(19) United States
(12) Patent Application Publication
(10) Pub. No.: US 2011/0158108 A1
(43) Pub. Date: Jun. 30, 2011

(54) ETHERENT PHYSICAL LAYER TEST SYSTEM AND METHOD

(76) Inventors: Yung-Ta CHAN, Hsinchu City (TW); Chien-Liang Chen, Banqiao City (TW); Shih-Ming Hwang, Taipei City (TW); Chun-Chi Chu, Jhubei City (TW); Che-Wei Chang, Taipei City (TW); Wei-Cheng Hung, Bade City (TW)

(21) Appl. No.: 12/768,959

(22) Filed: Apr. 28, 2010

(30) Foreign Application Priority Data
Dec. 25, 2009 (TW) 98145051

(51) Int. Cl. H04L 12/26

(52) U.S. Cl. 370/250

(57) ABSTRACT

An Ethernet physical layer test system and method, wherein a signal pattern generator is utilized to generate repeatedly a signal pattern frame required by the test items of the Ethernet physical layer according to a transmission procedure of a medium access controller; meanwhile, the signal pattern generator generates a control signal for switching a multiplexer, so as to control the transmission of a signal pattern frame. The Ethernet physical layer receives the signal pattern frame and outputs a test packet to a measurement instrument via a twisted-pair, for testing and analyzing quality of signals output by the Ethernet physical layer. Through the application of this Ethernet physical layer test system and method, the time required for testing the Ethernet physical layer can be effectively reduced, thus simplifying the complexity of an algorithm in testing the Ethernet physical layer.

### BACKGROUND OF THE INVENTION

1. Field of the Invention

The present invention relates to a test architecture, and in particular to an Ethernet physical layer test system and method, that is applicable to the testing of 10 BASE-T Ethernet physical layer.

2. The Prior Arts

In the Ethernet physical layer output signal quality Specification of IEEE 802.3 10BASE-T, such as paragraph 14.3.1.2.1 differential output voltage specification of IEEE 802.3, for a Transmitter Differential Output signal waveform TD+, TD−, all the data string signals must be compatible with the range of output waveform patterns. The voltage signal pattern of the outside medium connection unit has to be in the fold ratios of 0.9-1.1, and it is not allowed to go outside the range. Therefore, in order to measure correctly the quality of the signal output by Ethernet physical layer, in addition to the measurement instruments required, the object-under-test, namely, the Ethernet physical layer must send out the corresponding test signals required according to the test items for the measurement instrument to analyze quality of the signal. The test items and the corresponding test signals of Ethernet physical layer are as shown in Table (1) respectively. Therefore, in order for the object-under-test, namely, the Ethernet physical layer be able to output the corresponding test signals, a test signal generation means corresponding to the test items as shown in Table (1) must be incorporated into the system design.

As shown in FIG. 1, in general, the test signals are generated by a software driving program, such that the test signals required by test items in Table (1) are written according to the transmission procedure of a Medium Access Controller (MAC) 40, then they are stored in a transmission buffer of MAC 40, and finally test packets are transmitted to the physical layer via MAC 40.

TABLE (1)

| Test item | Test signal |
|---|---|
| Link Pulse | Link Pulse |
| MAU | Pseudo-random sequence |
| TP_IDL | Pseudo-random sequence |
| Jitter | Pseudo-random sequence |
| Differential Voltage | Pseudo-random sequence |
| Harmonic | All logic 1's or all logic 0's |
| Return Loss | Pseudo-random sequence |
| CM Voltage | Pseudo-random sequence |

However, in this way, since different software driving programs have to be written for different Medium Access Controllers (MAC) 40, so as to generate the test signals required, therefore, the testing of Ethernet physical layer is rather time-consuming, besides, the program designs of such software driving programs are much more complicated. Due to the shortcomings and drawbacks of the prior art, the present invention provides a Ethernet physical layer test system and method, that is capable of generating test signals repeatedly by means of a hardware circuit.

### SUMMARY OF THE INVENTION

A major objective of the present invention is to provide an Ethernet physical layer test system and method, wherein, a signal pattern generator generates signal pattern frames repeatedly according to test items for the Ethernet physical layer to proceed with the test, hereby reducing significantly the test time required.

Another object of the present invention is to provide an Ethernet physical layer test system and method, such that there is no need to write and generate signal pattern frames by means of software program as based on test items, thus simplifying significantly the complexity of development of the test software.

In order to achieve the above mentioned objective, the present invention provides an Ethernet physical layer test system and method, comprising a multiplexer, with its first input terminal and its second input terminal connected respectively to a medium access controller and a signal pattern generator; a medium access controller, provided with a transmission procedure, which is created according to the test items of the Ethernet physical layer, and the signal pattern generator generates a signal pattern frame and a control signal based on the transmission procedure, so as to control the transmission of the signal pattern frame to an Ethernet through controlling the switching of the multiplexer by means of the control signal; and an Ethernet, which is connected to an output terminal of the multiplexer, the Ethernet physical layer will receive the signal pattern frame and output a test packet, which is transmitted to a measurement instrument through a twisted-pair for testing and analyzing the quality of the signal output by the physical layer.

Further scope of the applicability of the present invention will become apparent from the detailed description given hereinafter. However, it should be understood that the detailed description and specific examples, while indicating preferred embodiments of the present invention, are given by way of illustration only, since various changes and modifications within the spirit and scope of the present invention will become apparent to those skilled in the art from this detailed description.

### BRIEF DESCRIPTION OF THE DRAWINGS

The related drawings in connection with the detailed description of the present invention to be made later are described briefly as follows, in which:

FIG. 1 is a schematic diagram of test structure for an Ethernet physical layer according to the prior art;

FIG. 2 is a schematic diagram of an Ethernet physical layer test system according to the present invention;

FIG. 3 is a schematic diagram of a signal pattern generator according to the present invention;

FIG. 4(a) is a schematic diagram of a first signal pattern generation register according to the present invention;

FIG. 4(b) is a schematic diagram of a second signal pattern generation register according to the present invention; and

FIG. 5 is a flowchart of the steps of an Ethernet physical layer test method according to the present invention.

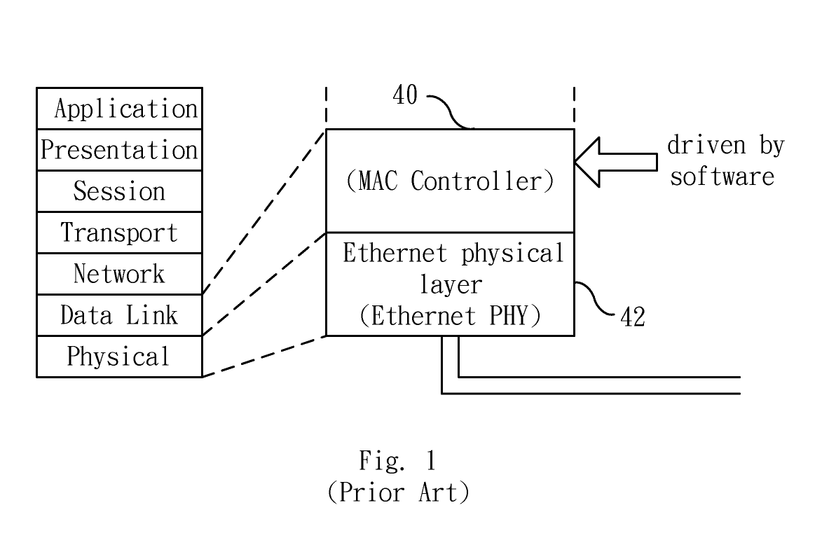

### DETAILED DESCRIPTION OF THE PREFERRED EMBODIMENT

The purpose, construction, features, functions and advantages of the present invention can be appreciated and understood more thoroughly through the following detailed description with reference to the attached drawings.

The present invention provides an Ethernet physical layer test system and method, wherein, a signal pattern generator is used to generate a signal pattern frame according to the test items of the Ethernet physical layer

so as to make the physical layer output a test packet to a measurement instrument for analyzing the quality of signal output by the physical layer. In the following, the preferred embodiments will be described in detail in explaining the technical characteristics of the present invention.

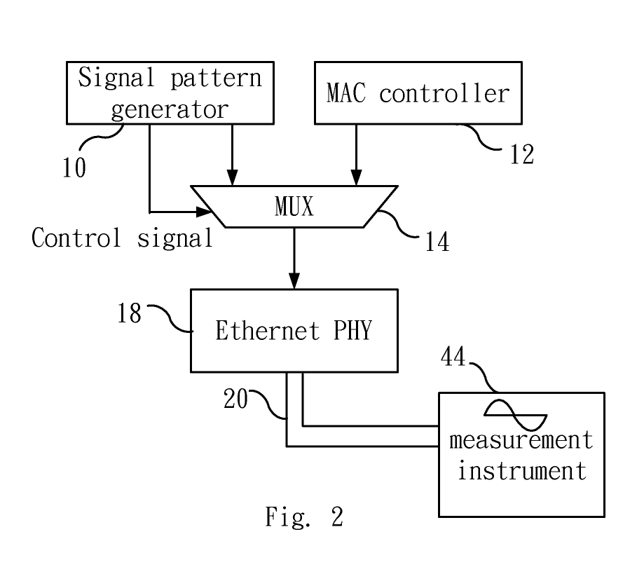

Firstly, refer to FIG. 2 for a schematic diagram of an Ethernet physical layer test system according to the present invention. As shown in FIG. 2, wherein, a signal pattern generator 10 and a medium access controller (MAC) 12 are connected respectively to a first input terminal and a second input terminal of a multiplexer 14; the medium access controller 12 is provided with a transmission procedure, which is generated according to the test items of the physical layer of an Ethernet 18, and the transmission speed of the Ethernet 18 is 10 million bits/second. The test items of the physical layer include: Link Pulse, MAU, TP_IDL, Jitter, Differential Voltage, Harmonic, Return Loss, and CM Voltage, etc., such that each of the test items corresponds to a signal pattern. The signal pattern generator 10 generates the corresponding signal pattern and control signal according to the transmission procedure of the medium access controller 12, and encapsulates the signal pattern into a signal pattern frame, and will control the transmission time of the signal pattern frame through controlling the switching of the multiplexer 14 by means of the control signal, such that the signal pattern frame is transmitted to a register inside the physical layer of the Ethernet 18 through the multiplexer 14. Upon receiving the signal pattern frame, the physical layer of Ethernet 18 will output a test packet, and transmit it to a measurement instrument 44 via an unshielded twisted-pair (UTP) 20 in proceeding with testing and analyzing the quality of signal output by the physical layer of Ethernet 18.

In the above descriptions, the structure of the Ethernet physical layer test system has been described, and in the following, the structure of signal pattern generator 10 and the generation of signal pattern frame and control signal will be described in detail.

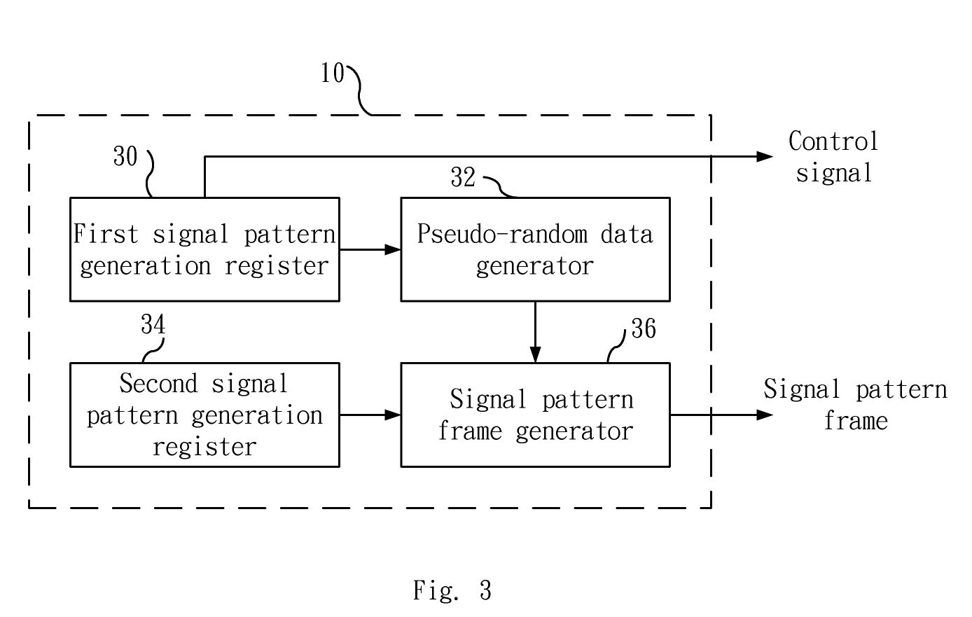

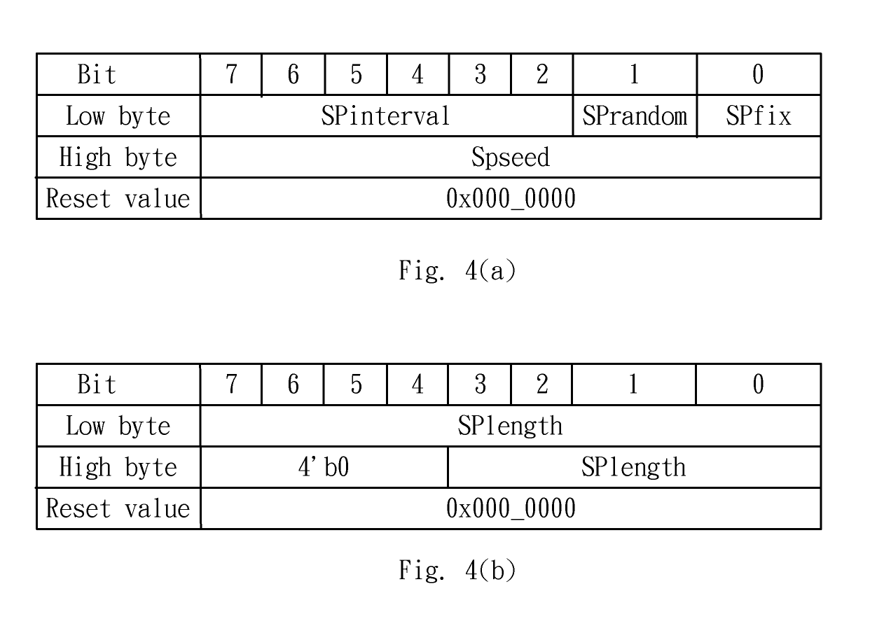

Next, refer to FIG. 3 for a schematic diagram of a signal pattern generator according to the present invention. As shown in FIG. 3, the signal pattern generator 10 includes: a first signal pattern generation register 30, a pseudo-random data generator 32, a second signal pattern generation register 34, and a signal pattern frame generator 36. The first signal pattern generation register 30 generates a Control Signal, a Signal Pattern Seed, and a Signal Pattern Interval Gap according to the test items of the transmission procedure. Meanwhile, refer to FIG. 4(a) for a schematic diagram of a first signal pattern generation register according to the present invention. As shown in FIG. 4(a), the first signal pattern generation register 30 includes bits 0-15, wherein, the 0^{th} bit represents a Signal Pattern Fix (SPfix), the first bit represents a Signal Pattern Random (SPrandom), the two bits are used as the control signal of the multiplexer 14; the 2^{nd}-7^{th} bits represent a Signal Pattern Interval Gap (SPinterval); the 8^{th}-15^{th} bits represent a Signal Pattern Seed (SPseed), which is a Data Pattern or a Pseudo-Random Seed, and is used as a source for generating signal pattern. The Signal Pattern Seed generated by the first signal pattern generation register 30 is fetched by a pseudo-random data generator 32, so as to generate the corresponding Signal Pattern, and transmit the Signal Pattern according to the Signal Pattern Interval Gap (SPinterval) generated by the first signal pattern generation register 30.

By way of an example, when the test item of the transmission procedure is a Link Pulse, then the 0^{th} bit and the first bit of the first signal pattern generation register 30 are all logical 0's, thus it will generate a control signal “00” for controlling the multiplexer 14, and that means that it will not generate a Signal Pattern Fix (SPfix) and a Signal Pattern Random (SPrandom). As such, the physical layer of Ethernet PHY 18 will output a Normal Link Pulse signal directly as a signal pattern.

When the test item of the transmission procedure is a Harmonic, then the 0^{th} bit of the first signal pattern generation register 30 is logical 1, and its first bit is logical 0, thus it will generate a control signal “01” for controlling the multiplexer 14, and that means that it will generate a Signal Pattern Fix (SPfix). As such, the pseudo-random data generator 32 will output a fixed data signal as a signal pattern, and all the bits of the fixed data signal are logic 0's or logic 1's.

When the test item of the transmission procedure is MAU, TP-IDL, Jitter, Differential Voltage, Return Loss or CM Voltage, etc., then the 0^{th} bit of the first signal pattern generation register 30 is logical 0, and its first bit is logical 1, thus it will generate a control signal “10” for controlling the multiplexer 14, and that means that it will generate a Signal Pattern Random (SPrandom). As such, the pseudo-random data generator 32 will fetch the Signal Pattern Seed (SPseed), and it will utilize a Scrambler contained therein to generate pseudo-random sequence data signals to serve as Signal Pattern. In addition, the second signal pattern generation register 34 will generate the corresponding frame length according to the test items of the transmission procedure. Refer to FIG. 4(b) simultaneously, the second signal pattern generation register 34 contains bits 0-15, wherein, the 0-11^{th} bits represent Signal Pattern Length (SPlength), and the 12-15^{th} bits are reserved, such that a signal pattern frame generator 36 will receive the signal pattern generated by the pseudo-random data generator 32, and the frame length generated by the second signal pattern generation register 34, and combine them into a signal pattern frame, and then transmit it to the physical layer of Ethernet 18. In the above descriptions, the structure and operation of Signal Pattern Generator 10 are described, and in the following, the Ethernet physical layer test method will be described in detail.

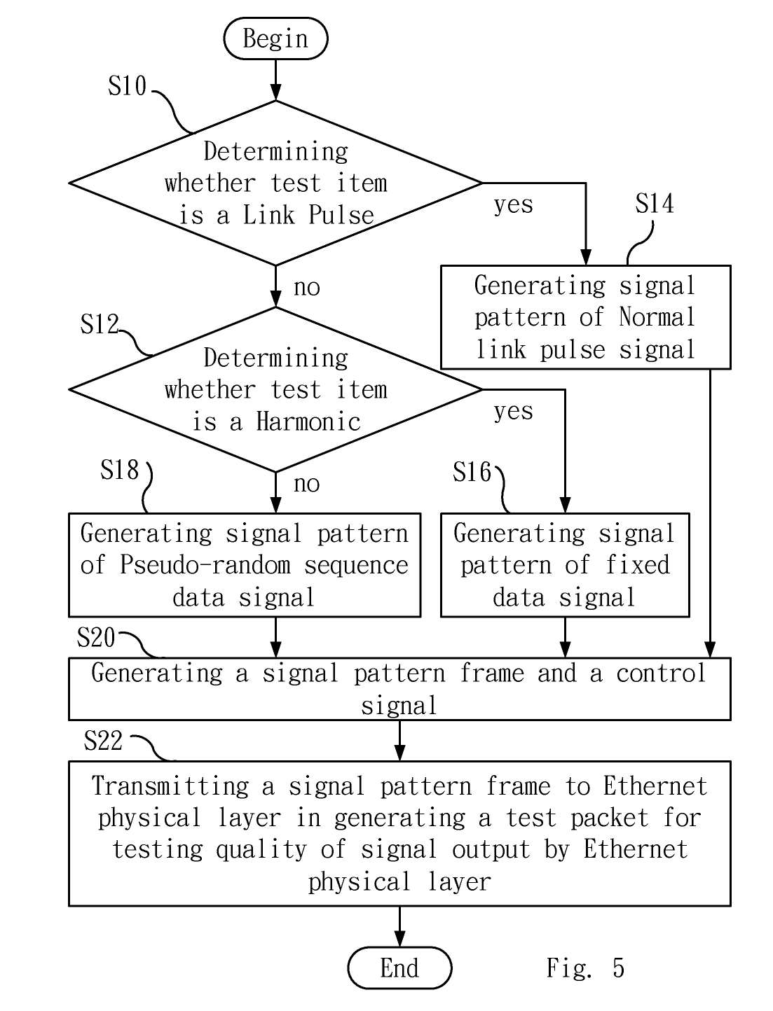

Subsequently, refer to FIG. 5 for a flowchart of the steps of an Ethernet physical layer test method according to the present invention, also refer to FIGS. 2 and 3 simultaneously. As shown in FIG. 5, firstly, as shown in step S10, determining if the test item is a Link Pulse according to the transmission procedure of the medium access controller 12, and when the test item is a Link Pulse, then as shown in step S14, the first signal pattern generation register 30 and the second signal pattern generation register 34 contained in the signal pattern generator 10 will not generate a Signal Pattern Fix (SPfix) and a Signal Pattern Random (SPrandom); then, as shown in step S20 the first signal pattern generation register 30 generates a control signal on controlling the switching of the multiplexer; and finally, as shown in step S22, a Normal Link Pulse signal directly as a signal pattern transmitting by physical layer of Ethernet PHY 18 to a measurement instrument 44 via an unshielded twisted-pair (UTP) 20 for testing the quality of the output signal of the physical layer.

However, when the test item is not a Link Pulse, then as shown in step S12, determining if the test item of a transmission procedure is a Harmonic, and when the test item is a Harmonic, then as shown in step S16, the first signal pattern generation register 30 and the second signal pattern generation register 34 generate a signal pattern and a frame length respectively corresponding to the test item of the Harmonic, such that the signal pattern is a fixed data signal; then, as shown in step S20, a signal pattern frame generator 36 will combine the signal pattern and the frame length of the fixed data signal into a signal pattern frame, meanwhile, the first signal pattern generation register 30 will generate a control signal in controlling the switching of the multiplexer 14, so as to control the output of the signal pattern frame; and finally, as shown in step S22, transmitting the signal pattern frame to a physical layer of the Ethernet PHY 18, and then after generating a test packet, transmitting it to a measurement instrument 44 via an unshielded twisted-pair (UTP) 20 for testing and analyzing the quality of the output signal of the physical layer.

When the test item is not a Harmonic, then that means that the test item of the transmission procedure is one of the following: MAU, TP_IDL, Jitter, Differential Voltage, Return Loss, and CM Voltage, etc., then as shown in step S18, the first signal pattern generation register 30 and the second signal pattern generation register 34 generate a signal pattern and a frame length respectively corresponding to the test item of the pseudo-random sequence data signal; then, as shown in step S20, the signal pattern frame generator 36 will combine the signal pattern and frame length of the pseudo-random sequence data signal into a signal pattern frame, meanwhile, the first signal pattern generation register 30 will generate a control signal in controlling the output of the signal pattern frame; and finally, as shown in step S22, transmitting the signal pattern frame to a physical layer of the Ethernet PHY 18 for generating and transmitting a test packet to a measurement instrument 44 via an unshielded twisted-pair (UTP) 20 for testing the quality of the output signal of the physical layer.

Through the description of the Embodiments mentioned above, it can be known that, in the present invention, an embedded signal pattern frame generator 36 is utilized to generate the signal pattern frame required in testing the physical layer of an Ethernet PHY 18. As such, the signal pattern frame generator 36 is able to generate repeatedly a signal pattern corresponding to a test item in producing a signal pattern frame according to a test item of a physical layer of the Ethernet PHY 18, without having to generate signal patterns through a software as based on a transmission procedure of a medium access controller 12 and storing them in a transmission buffer of the medium access controller 12, such that through the application of the present invention, the time required for testing Ethernet physical layer can be shortened effectively, hereby enhancing its test efficacy.

The above detailed description of the preferred embodiment is intended to describe more clearly the characteristics and spirit of the present invention. However, the preferred embodiments disclosed above are not intended to be any restrictions to the scope of the present invention. Conversely, its purpose is to include the various changes and equivalent arrangements which are within the scope of the appended claims.

What is claimed is:

1. An Ethernet physical layer test system, comprising:
a multiplexer, which is provided with a first input terminal, a second input terminal and an output terminal;
a medium access controller, which is connected to the first input terminal of the multiplexer, and is provided with a transmission procedure;
a signal pattern generator, which is connected to the second input terminal of the multiplexer, and generates a signal pattern frame and a control signal according to the transmission procedure, the control signal is used to control switching of the multiplexer and control transmission of the signal pattern frame; and
an Ethernet, which is connected to the output terminal of the multiplexer, the physical layer of the Ethernet is used to receive the signal pattern frame, and output a test packet for testing quality of an output signal of the physical layer.

2. The Ethernet physical layer test system as claimed in claim 1, wherein
the test packet is transmitted to a measurement instrument via a twisted-pair.

3. The Ethernet physical layer test system as claimed in claim 1, wherein
a network transmission speed of the Ethernet is 10 million bits/sec.

4. The Ethernet physical layer test system as claimed in claim 2, wherein
the twisted-pair is an unshielded twisted-pair (UTP).

5. The Ethernet physical layer test system as claimed in claim 1, wherein
the transmission procedure is created according to a test item of the Ethernet physical layer.

6. The Ethernet physical layer test system as claimed in claim 5, wherein
the test item of the Ethernet physical layer includes: Link Pulse, MAU, TP_IDL, Jitter, Differential Voltage, Harmonic, Return Loss, and CM Voltage, such that each of the test items is provided with a corresponding signal pattern.

7. The Ethernet physical layer test system as claimed in claim 6, wherein
the signal pattern generator includes:
a first signal pattern generation register, which is used to generate the control signal and a Signal Pattern Seed (SPseed) according to the transmission procedure;
a pseudo-random data generator, which is connected to the first signal pattern generation register, and is used to receive the signal pattern seed in generating the signal pattern;
a second signal pattern generation register, which is used to generate a frame length of the signal pattern frame according to the transmission procedure; and
a signal pattern frame generator, which is connected to the first signal pattern generation register and the second signal pattern generation register, and is used to receive the signal pattern and the frame length in generating the signal pattern frame.

8. The Ethernet physical layer test system as claimed in claim 7, wherein
the first signal pattern generation register further generates a Signal Pattern Interval Gap (SPinterval).

9. The Ethernet physical layer test system as claimed in claim 7, wherein
the signal pattern is a Normal Link Pulse signal, a fixed data signal, or a pseudo-random sequence data signal.

10. The Ethernet physical layer test system as claimed in claim 9, wherein
the fixed data signal includes the bits which are all logic 0's or logic 1's.

11. The Ethernet physical layer test system as claimed in claim 9, further comprising:
a scrambler, which is disposed in the pseudo-random data generator, and is used to fetch the Signal Pattern Seed (SPseed) for generating the pseudo-random sequence data signal.

12. An Ethernet physical layer test method, comprising following steps of:
determining a test item according to a transmission procedure;
generating a corresponding signal pattern and a frame length according to the test item, and combining them into a signal pattern frame, furthermore generating a control signal for controlling output of the signal pattern frame; and
transmitting the signal pattern frame to a physical layer of an Ethernet, and generating a test packet for testing quality of an output signal of the physical layer.

13. The Ethernet physical layer test method as claimed in claim 12, wherein
in the step of determining the test item, firstly, determining if the test item is a Link Pulse, and when the test item is the Link Pulse, then, in the step of generating the corresponding signal pattern and the frame length, the signal pattern generated is a Normal link pulse signal; and when the test item is not the Link Pulse, determining if the test item is a Harmonic, and when the test item is the Harmonic, then, in the step of generating the corresponding signal pattern and the frame length, the signal pattern generated is a fixed data signal; and finally, when the test item is not the Harmonic, then, in the step of generating the corresponding signal pattern and the frame length, the signal pattern generated is a pseudo-random sequence data signal.

14. The Ethernet physical layer test method as claimed in claim 12, wherein
the test item of the Ethernet physical layer includes: Link Pulse, MAU, TP_IDL, Jitter, Differential Voltage, Harmonic, Return Loss, and CM Voltage, such that each of the test items is provided with the corresponding signal pattern.

15. The Ethernet physical layer test method as claimed in claim 12, wherein
the signal pattern is a Normal Link Pulse signal, a fixed data signal, or a pseudo-random sequence data signal.

16. The Ethernet physical layer test method as claimed in claim 15, wherein
the fixed data signal includes the bits which are all logic 0's or logic 1's.

17. The Ethernet physical layer test method as claimed in claim 15, wherein
the pseudo-random sequence data signal utilizes a Signal Pattern Seed (SPseed) as a source of a random number.
